(19) United States
(12) Patent Application Publication
(10) Pub. No.: US 2020/0215436 A1
(43) Pub. Date: Jul. 9, 2020

(54) METHOD FOR SIMULTANEOUSLY TRANSLATING LANGUAGE OF GAME DEVICE AND RELATED PRODUCTS

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 16/354,220

(22) Filed: Mar. 15, 2019

(30) Foreign Application Priority Data
Jan. 4, 2019 (CN) 201910008953.5

(51) Int. Cl. A63F 13/60; G06F 17/28; A63F 13/54; A63F 13/25

(52) U.S. Cl. CPC A63F 13/60; G06F 17/289; A63F 2300/6081; A63F 13/25; A63F 2300/6009; A63F 13/54

(57) ABSTRACT

The present application provides a method for simultaneously translating a language of a game device and the related products, wherein the method comprises: determining, by the game device, the original language of the first game when running the first game; calling, by the game device, a preset cyclic neural network when determining that the original language is inconsistent with a system language; obtaining, by the game device, input data from the original language of the first game, inputting the input data into the preset cyclic neural network for operation to obtain an output result, obtaining a translated language of the system language according to the output result, and displaying or playing the translated language.

### CROSS REFERENCE TO RELATED APPLICATION

The present application claims priority to Chinese patent application No. 201910008953.5, entitled “Method for Simultaneously Translating Language of Game Device and Related Products”, filed on Jan. 24, 2019, the entire content of which is incorporated herein by reference.

### TECHNICAL FIELD

The present application relates to the field of games and terminals, and in particular to a method for simultaneously translating a language of a game device and related products.

### BACKGROUND

Game devices, such as smart phones, have become the most commonly used game devices. There are a lot of game developers in many countries nowadays. Games developed in different countries generally use their native languages. For example, Chinese games use Chinese, and American games use English. Some games are available in different languages, but this is only for large game providers. Ordinary games do not provide corresponding language translations, which affects the game experience.

### SUMMARY

The embodiments of the present application provide a method for simultaneously translating the language of a game device and related products, which translates the language of the game, thereby improving the user experience.

According to the first embodiment, the present application provides a method for simultaneously translating the language of a game device, wherein the method comprises the steps of:

determining, by the game device, the original language of the first game when running the first game;

calling, by the game device, a preset cyclic neural network when determining that the original language is inconsistent with a system language;

obtaining, by the game device, input data from the original language of the first game, inputting the input data into the preset cyclic neural network for operation to obtain an output result, obtaining a translated language of the system language according to the output result, and displaying or playing the translated language.

Preferably, the preset cyclic neural network comprises: an input layer, a hidden layer, and an output layer, and inputting the input data into the preset cyclic neural network for operation to obtain an output result specifically comprises:

obtaining the input data Xₜ and weight W at the time t of the input layer of the cyclic neural network, obtaining the output result Sₜ₋₁ at the previous time of the time t of the hidden layer; and calculating the output result Sₜ at the time t of the hidden layer and the output result Oₜ at the time t of the output layer.

Preferably, calculating the output result Sₜ at the time t of the hidden layer and the output result Oₜ at the time t of the output layer specifically comprises:

adding the matrix hₜ₋₁*M of the output result Sₜ₋₁ to the matrix hₜ*M of the input data Xₜ to obtain a new matrix (hₜ₋₁+hₜ)*M; wherein M denotes a row value of the matrix, hₜ₋₁ and hₜ denote column values of the matrix; calculating the matrix (hₜ₋₁+hₜ)*M and the matrix M*E of the weight W to obtain the calculating result (hₜ₋₁+hₜ)*E, dividing the calculating result (hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

Preferably, the activation operation is: a sigmoid function or a tanh function.

According to the second embodiment, there is provided a game device, wherein the game device comprises:

an obtaining unit configured to determine the original language of the first game when running the first game;

a calling unit configured to call a preset cyclic neural network when determining that the original language is inconsistent with a system language;

a processing unit configured to obtain input data from the original language of the first game, input the input data into the preset cyclic neural network for operation to obtain an output result, obtain a translated language of the system language according to the output result, and display or play the translated language.

Preferably, the processing unit is specifically configured to obtain the input data Xₜ and weight W at the time t of the input layer of the cyclic neural network, obtain the output result Sₜ₋₁ at the previous time of the time t of the hidden layer; and calculate the output result Sₜ at the time t of the hidden layer and the output result Oₜ at the time t of the output layer.

Preferably, the processing unit is specifically configured to add the matrix hₜ₋₁*M of the output result Sₜ₋₁ to the matrix hₜ*M of the input data Xₜ to obtain a new matrix (hₜ₋₁+hₜ)*M; wherein M denotes a row value of the matrix, both hₜ₋₁ and hₜ denote column values of the matrix; calculate the matrix (hₜ₋₁+hₜ)*M and the matrix M*E of the weight W to obtain the calculating result (hₜ₋₁hₜ)*E, divide the calculating result (hₜ₋₁+hₜ)*E into the matrix hₜ₋₁*E and the matrix hₜ*E, sum the matrix hₜ₋₁*E and the matrix hₜ*E to obtain an output result Sₜ; and perform an activation operation on Sₜ to obtain Oₜ.

Preferably, the activation operation is: a sigmoid function or a tanh function.

Preferably, the game device is: a smart phone or a tablet.

According to the third embodiment, there is provided a computer readable storage medium in which a computer program for exchanging electronic data is stored, wherein the computer program causes the computer to perform the method provided by the first embodiment.

According to the fourth embodiment, there is provided a computer program product, wherein the computer program product comprises a non-transitory computer readable storage medium in which a computer program is stored, and the computer program is operable to cause the computer to perform the method provided by the first embodiment.

The implementation of the embodiments of the present application has the following beneficial effects:

It can be seen that the technical solution provided by the present application calls the cyclic neural network to translate the original language to obtain a translated language when determining that the original language of the first game is inconsistent with the system language, and displays or plays the translated language, thereby translating the language of the first game to improve the user experience.

### BRIEF DESCRIPTION OF THE DRAWINGS

In order to more clearly illustrate the technical solution in the embodiments of the present application, the drawings used in the description of the embodiments will be briefly described below. Obviously, the drawings in the following description are some embodiments of the present application. Those skilled in the art can also obtain other drawings based on these drawings without paying any creative work.

FIG. 1 is a schematic structural diagram of a computing device according to an embodiment of the present application.

FIG. 2 is a flow schematic diagram of a method for simultaneously translating a language of a game device according to an embodiment of the present application.

FIG. 3 is a schematic diagram of a cyclic neural network according to an embodiment of the present application.

FIG. 4 is a schematic diagram of a game device according to an embodiment of the present application.

### DESCRIPTION OF THE EMBODIMENTS

The technical solution in the embodiments of the present application is clearly and completely described below with reference to the accompanying drawings in the embodiments of the present application. Obviously, the described embodiments are a part of the embodiments of the present application, rather than all of the embodiments. All other embodiments obtained by those skilled in the art based on the embodiments of the present application without paying any creative work are within the scope of protection of the present application.

The terms, such as “first”, “second”, “third” and “fourth” etc., in the specification and claims of the present application and the accompanying drawings are used to distinguish different objects, and are not intended to describe a specific order. Furthermore, the terms “comprise” and “have” and any variations thereof are intended to cover a non-exclusive inclusion. For example, a process, method, system, product, or device that comprises a series of steps or units is not limited to the listed steps or units, but optionally comprises steps or units that are not listed, or optionally comprises other steps or units inherent to these processes, methods, products or devices.

References to “an embodiment” herein mean that a particular feature, structure, or characteristic described in connection with the embodiments can be included in at least one embodiment of the present application. The appearances of the phrase in various places in the specification are not necessarily referring to the same embodiments, and are not exclusive or alternative embodiments that are mutually exclusive from other embodiments. Those skilled in the art will explicitly and implicitly understand that the embodiments described herein can be combined with other embodiments.

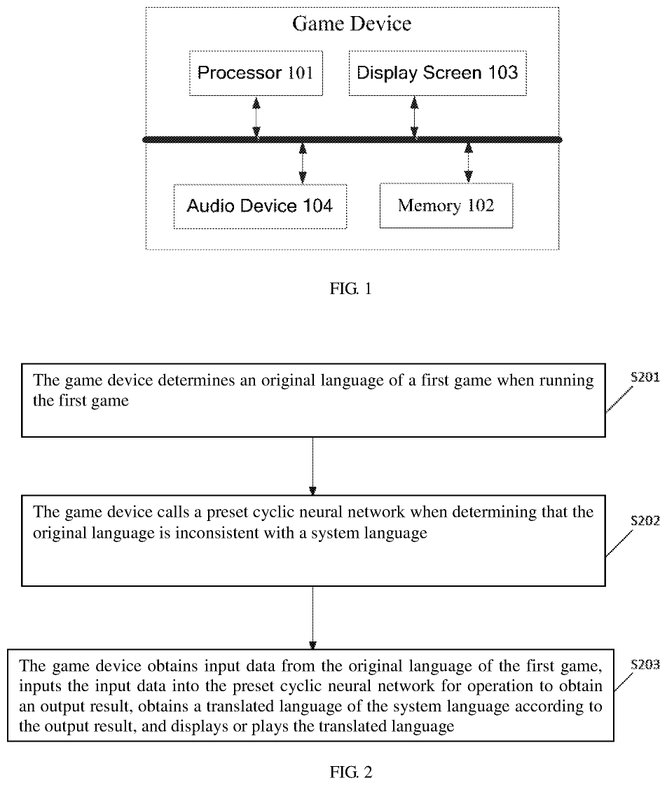

Referring to FIG. 1, FIG. 1 is a schematic structural diagram of a game device. As shown in FIG. 1, the game device may comprise: a processor 101, a memory 102, a display screen 103, and an audio device 104, wherein the processor 101 is connected to the memory 102, the display screen 103, and the audio device 104 via a bus.

One embodiment provides a method for simultaneously translating a language of a game device. The method is implemented using the game device as shown in FIG. 1. As shown in FIG. 2, the method comprises the following steps:

Step S201, the game device determines an original language of a first game when running the first game;

Step S202, the game device calls a preset cyclic neural network when determining that the original language is inconsistent with a system language;

Step S203, the game device obtains input data from the original language of the first game, inputs the input data into the preset cyclic neural network for operation to obtain an output result, obtains a translated language of the system language according to the output result, and displays or plays the translated language.

Obtaining a translated language of the system language according to the output result may adopt the method of obtaining the existing cyclic neural network model, such as the Google cyclic neural network model, and the Baidu neural network model. The cyclic neural network can also refer to the paper about the cyclic neural network.

The technical solution provided by the present application calls the cyclic neural network to translate the original language to obtain a translated language when determining that the original language of the first game is inconsistent with the system language, and displays or plays the translated language, thereby translating the language of the first game to improve the user experience.

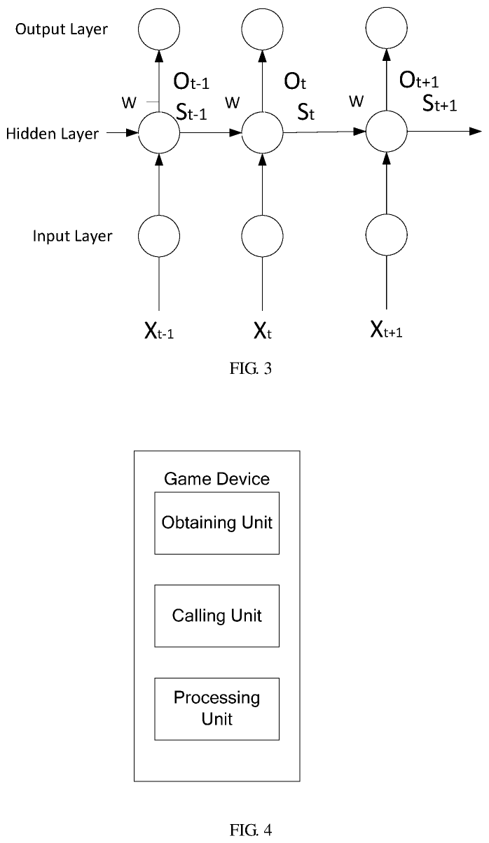

The cyclic neural network is a neural network model commonly used for speech translation. The cyclic neural network has a structure as shown in FIG. 3, comprising an input layer, a hidden layer, and an output layer. The output structure of the hidden layer is used as an input data of the hidden layer of the next time.

As shown in FIG. 3, for example, the output result of the hidden layer at the time t is the output of the hidden layer at the next time t+1.

As shown in FIG. 3, W denotes a weight, Xₜ₋₁ denotes the input data of the input layer at the time t−1, Xₜ denotes the input data of the input layer at the time t, Sₜ₋₁ denotes the output result of the hidden layer at the time t−1, and Oₜ₋₁ denotes the output result of the output layer at the time t−1;

Take time t as an example:

Sₜ=w×Xₜ+w×Sₜ₋₁

Oₜ=f(Sₜ)

Where f denotes an activation function, including, but not limited to, a sigmoid function, a tanh function, etc.

$$sigmoid ( x ) = \frac{1}{1 - {e}^{x}} tan h ( x ) = \frac{{e}^{x} - {e}^{- x}}{{e}^{x} + {e}^{- x}}$$

Apparently, in the actual application, other activation functions can also be used.

Inputting the input data into the preset cyclic neural network for operation to obtain an output result specifically comprises:

obtaining the input data Xₜ and weight W at the time t of the input layer of the cyclic neural network, obtaining the output result Sₜ₋₁ at the previous time of the time t of the hidden layer; and calculating the output result Sₜ at the time t of the hidden layer and the output result Oₜ at the time t of the output layer.

Calculating the output result Sₜ at the time t of the hidden layer may specifically comprise:

adding the matrix hₜ₋₁*M of the output result Sₜ₋₁ to the matrix hₜ*M of the input data Xₜ to obtain a new matrix (hₜ₋₁+hₜ)*M; wherein M denotes a row value of the matrix, hₜ₋₁ and hₜ denote column values of the matrix; calculating the matrix (hₜ₋₁+hₜ)*M and the matrix M*E of the weight W to obtain the calculating result (hₜ₋₁+hₜ)*E, dividing the calculating result (hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

The technical solution of the present application combines the output result Sₜ₋₁ and the input data Xₜ into a new matrix, so that the quadratic matrix multiplication operation becomes one-order matrix multiplication operation. Although the calculation amount is the same, the quadratic matrix operation becomes one-order matrix multiplication operation so as to be capable of transmitting the weight W once less, that is, the weight W is only completely extracted once, which improves the efficiency of data extraction, improves the calculation efficiency, reduces the power consumption and reduces the heat dissipation.

Preferably, prior to calculating the matrix (hₜ₋₁+hₜ)*M and the matrix M*E of the weight W to obtain the calculating result (hₜ₋₁+hₜ)*E, the above method may further comprise: if the M cannot be divisible by 4, dividing the new matrix (hₜ₋₁+hₜ)*M into m input data blocks in the column direction. The first m−1 input data blocks in m are 4 column elements, and the last input data block is r column elements. The first m−1 input data blocks are stored first in rows and then in columns. The storage method of the last input data block is determined according to the value of r.

Specifically, the method may comprise:

if r=1, storing the last column of elements in the column direction, if r=2, storing the last two columns of elements first in rows and then in columns, if r=3, adding a column of zero elements at the edge to obtain the added data block, and storing the added data blocks first in rows and then in columns. The above r is the remainder of M/4.

wherein m=[M/4]+1

The above method may further comprise: if M cannot be divisible by 4, dividing the matrix M*E into m input data blocks in the row direction, wherein the first m−1 input data blocks in m are 4 row elements, the last input data block is r column elements, and the first m−1 input data blocks are stored first in columns and then in rows; if r=1, storing the last row of elements in the row direction, if r=2, storing the last two rows of elements first in columns and then in rows, if r=3, adding a row of zero elements at the edge to obtain the added data block, and storing the added data blocks first in columns and then in rows.

Referring to FIG. 4, FIG. 4 provides a game device, wherein the game device comprises:

an obtaining unit configured to determine the original language of the first game when running the first game;

a calling unit configured to call a preset cyclic neural network when determining that the original language is inconsistent with a system language;

a processing unit configured to obtain input data from the original language of the first game, input the input data into the preset cyclic neural network for operation to obtain an output result, obtain a translated language of the system language according to the output result, and display or play the translated language.

The above game device may specifically be a smart phone or a tablet.

Another embodiment of the present application further provides a computer readable storage medium, wherein a computer program for exchanging electronic data is stored in the computer readable storage medium, wherein the computer program causes the computer to perform some or all of the steps of any method for simultaneously translating a language of a game device as described in the above method embodiments.

Another embodiment of the present application further provides a computer program product, wherein the computer program product comprises a non-transitory computer readable storage medium in which a computer program is stored, and the computer program is operable to cause the computer to perform some or all of the steps of any method for simultaneously translating a language of a game device as described in the above method embodiments.

It should be noted that, for the sake of brevity, each of the above method embodiments is described as a combination of a series of actions, but those skilled in the art should understand that the present application is not limited by the described action sequence because certain steps may be performed in other sequences or concurrently in accordance with the present application. In addition, those skilled in the art should also understand that the embodiments described in the specification are all optional embodiments, and the actions and modules involved are not necessarily required by the present application.

In the above embodiments, the description of each of the embodiments has its own emphasis, and the parts that are not detailed in a certain embodiment can refer to the related descriptions of other embodiments.

In the several embodiments provided by the present application, it should be understood that the disclosed device may be implemented in other ways. For example, the device embodiments described above are merely illustrative. For example, the division of the unit is only a logical function division. In actual implementation, there may be another division manner. For example, a plurality of units or components may be combined or may be integrated into another system, or some features may be ignored or not executed. In addition, the mutual coupling or direct coupling or communication connection shown or discussed may be an indirect coupling or communication connection through some interfaces, devices or units, and may be electrical or in other forms.

The units described as separate components may or may not be physically separated, and the components displayed as units may or may not be physical units, that is, may be located in one place, or may be distributed to a plurality of network units. Some or all of the units may be selected according to actual needs to achieve the purpose of the solution of the embodiment.

In addition, each of the functional units in each of the embodiments of the present application may be integrated into one processing unit, or each of the units may exist physically separately, or two or more of the units may be integrated into one unit. The above integrated unit may be implemented in the form of hardware or in the form of a software program module.

If implemented in the form of a software program module and sold or used as a standalone product, the integrated unit may be stored in a computer readable memory. Based on such understanding, the technical solution of the present application in essence, or the part making contributions to the prior art, or all or some of the technical solution may be embodied in the form of a software product. The computer software product is stored in a memory, comprising several instructions to cause the computer device (which may be a personal computer, a server or a network device, etc.) to perform all or some of the steps of the methods described in each of the embodiments of the present application. The above memory comprises various media, such as: a USB flash disk, a Read-Only Memory (ROM), a Random Access Memory (RAM), a removable hard disk, a magnetic disk, or an optical disk, in which program codes may be stored.

Those skilled in the art can understand that all or some of steps in each of the methods of the above embodiments can be completed by a program to instruct related hardware. The program can be stored in a computer readable memory, and the memory may comprise: a flash drive, a Read-Only Memory (ROM), a Random Access Memory (RAM), a magnetic disk or an optical disk, etc.

The embodiments of the present application have been described in detail above. Specific examples are applied herein to set forth the principles and embodiments of the present application. The description of the above embodiments is only used to help understand the method of the present application and its core ideas; at the same time, those skilled in the art will have a change in the specific embodiments and the scope of application according to the idea of the present application. In summary, the content of the present specification should not be construed as limiting the present application.

What is claimed is:

1. A method for simultaneously translating a language of a game device, wherein the method comprises:
determining, by the game device, an original language of a first game when running the first game;
calling, by the game device, a preset cyclic neural network when determining that the original language is inconsistent with a system language;
obtaining, by the game device, input data from the original language of the first game, inputting the input data into the preset cyclic neural network for operation to obtain an output result, obtaining a translated language of the system language according to the output result, and displaying or playing the translated language.

2. The method of claim 1, wherein the preset cyclic neural network comprises: an input layer, a hidden layer, and an output layer,
and the step of inputting the input data into the preset cyclic neural network for operation to obtain an output result comprises:
obtaining the input data Xₜ and weight W at the time t of the input layer of the cyclic neural network, obtaining the output result Sₜ₋₁ at the previous time of the time t of the hidden layer; and calculating the output result Sₜ at the time t of the hidden layer and the output result Oₜ at the time t of the output layer.

3. The method of claim 2, wherein the step of calculating the output result Sₜ at the time t of the hidden layer and the output result Oₜ at the time t of the output layer comprises:
adding the matrix hₜ₋₁*M of the output result Sₜ₋₁ to the matrix hₜ*M of the input data Xₜ to obtain a new matrix (hₜ₋₁+hₜ)*M; wherein M denotes a row value of the matrix, both hₜ₋₁ and hₜ denote column values of the matrix; calculating the matrix (hₜ₋₁+hₜ)*M and the matrix M*E of the weight W to obtain the calculating result (hₜ₋₁+hₜ)*E, dividing the calculating result (hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

4. The method of claim 3, wherein:
the activation operation is a sigmoid function or a tanh function.

5. A game device comprising:
an obtaining unit configured to determine an original language of a first game when running the first game;
a calling unit configured to call a preset cyclic neural network when determining that the original language is inconsistent with a system language;
a processing unit configured to obtain input data from the original language of the first game, input the input data into the preset cyclic neural network for operation to obtain an output result, obtain a translated language of the system language according to the output result, and display or play the translated language.

6. The gaming device of claim 5, wherein
the processing unit is configured to obtain the input data Xₜ and weight W at the time t of the input layer of the cyclic neural network, obtain the output result Sₜ₋₁ at the previous time of the time t of the hidden layer; and calculate the output result Sₜ at the time t of the hidden layer and the output result Oₜ at the time t of the output layer.

7. The gaming device of claim 6, wherein:
the processing unit is configured to add the matrix hₜ₋₁*M of the output result Sₜ₋₁ to the matrix hₜ*M of the input data Xₜ to obtain a new matrix (hₜ₋₁+hₜ)*M; wherein M denotes a row value of the matrix, both hₜ₋₁and hₜ denote column values of the matrix; calculate the matrix (hₜ₋₁+hₜ)*M and the matrix M*E of the weight W to obtain the calculating result (hₜ₋₁+hₜ)*E, divide the calculating result (hₜ₋₁+hₜ)*E into the matrix hₜ₋₁*E and the matrix hₜ*E, sum the matrix hₜ₋₁*E and the matrix hₜ*E to obtain an output result Sₜ; and perform an activation operation on Sₜ to obtain Oₜ.

8. The gaming device of claim 7, wherein the activation operation is a sigmoid function or a tanh function.

9. The gaming device of claim 5, wherein the game device is a smart phone or a tablet.

10. A computer readable storage medium in which a computer program for exchanging electronic data is stored, wherein the computer program causes the computer to perform the method according to claim 1.
